(19) United States
(12) Patent Application Publication
(10) Pub. No.: US 2012/0250208 A1
(43) Pub. Date: Oct. 4, 2012

(54) Electronic Switch and Circuit for Select-Fire Perforating Guns

(75) Inventors: Lyle G. Love, Weatherford, OK (US); Sanford E. Stark, Weatherford, OK (US); Frank L. Lezu, JR., Weatherford, OK (US); John R. Harris, Weatherford, OK (US); Brian S. Buffington, Weatherford, OK (US); Michael W. Dobrinski, Weatherford, OK (US); Jason C. Mailand, The Woodlands, TX (US); Demetri M. White, The Woodlands,, TX (US)

(73) Assignees: CASEDHOLE SOLUTIONS, INC., Weatherford, OK (US); TEJAS COMPLETION SOLUTIONS, LP, The Woodlands, TX (US)

(21) Appl. No.: 13/073,399

(22) Filed: Mar. 28, 2011

(51) Int. Cl. H01H 47/00; E21B 33/12; E21B 43/11

(52) U.S. Cl. 361/166; 89/1.15; 166/135

(57) ABSTRACT

Apparatus and method are provided for select-firing of perorating guns or activating other equipment in a well, such as a bridge plug. Double-pole double-throw electronic relays, used along with diodes that block voltage below a selected level, are used to control access of positive or negative voltages to blasting caps. Firing of a blasting cap causes an open circuit across the blasting cap and shifting of a relay. Alternate application of negative and positive voltages allows activation of multiple devices in a well.

### BACKGROUND OF INVENTION

1. Field of the Invention

This invention relates to perforating well casing. More particularly, apparatus and method are provided for selective firing of multiple guns with a relay switch.

2. Description of Related Art

Casings in wells for producing or injecting fluids are cemented in a wellbore and holes are formed in the casing at selected locations opposite certain subterranean formations by a device called a “perforating gun.” The gun usually is made up of shaped charges that are detonated by a blasting cap. The cap is activated by an electrical current. In many wells it is desirable to perforate casing over larger distances in the wellbore than can be accommodated by one perforating gun. To avoid running perforating guns hi the wellbore and withdrawing the spent charges repeatedly, it is advantageous to place a plurality of perforating charges or groups of charges in the well simultaneously and to shoot the charges selectively when placed opposite the selected subterranean formation. This capability is called “select-fire,” and it is old in the art.

Examples of apparatus for selectively firing perforating charges are disclosed in U.S. Pat. Nos. 5,531,164; 5,700,969; and 7,387,162. The electrical circuits in the devices are designed such that charges are fired sequentially by alternately applying a negative and a positive electrical voltage to the device. The circuits also include a mechanical device, referred to as a “dart.” The dart is disposed between chambers of a perforating charge or multiple charges that are to be fired selectively. The function of the dart is to electrically ground a blasting cap in the adjacent second chamber when the charges are fired in a first chamber. The electrical circuits are such that the perforating charges cannot be fired until the blasting cap for those charges is grounded. The dart moves in response to the shockwave pressure in the first chamber to place electrical conductors in contact, thus grounding the blasting cap.

One problem with darts is that about 1 in 120 devices now in use in industry fail and cause a misfire (lack of firing) of subsequent charges in a sequence of select-fire charges. This failure requires that the perforating apparatus be withdrawn from a well and another apparatus run into the well. This can be a very costly failure, particularly in deep wells, offshore wells and other wells in high-cost operating areas.

What is needed is a device and an electrical circuit to replace the mechanical darts such that select-firing can be achieved by alternating the electrical voltage applied to the device between positive and negative and switching to sequentially activate blasting caps, which may be used to fire perforating charges or perform other downhole operations.

### BRIEF SUMMARY OF THE INVENTION

A select-fire device is provided employing an electronic relay circuit.

A test device is provided that may be used to reset the respective switch relays for reuse (of the device) or to verify that the circuit is operable before deploying the select-fire device in a well.

### BRIEF DESCRIPTION OF THE SEVERAL VIEWS OF THE DRAWING(S)

The numerals identify the same part in each drawing.

FIG. 1 is an electrical schematic of one embodiment of the electronic switch disclosed herein.

FIGS. 2(a), 2(b) and 2(c) illustrate one embodiment of the mechanical arrangement of a perforating tool with the switches disclosed herein.

FIG. 3 is an electrical schematic of a test and resetting circuit device showing the resetting of a negative switch.

### DETAILED DESCRIPTION OF THE INVENTION

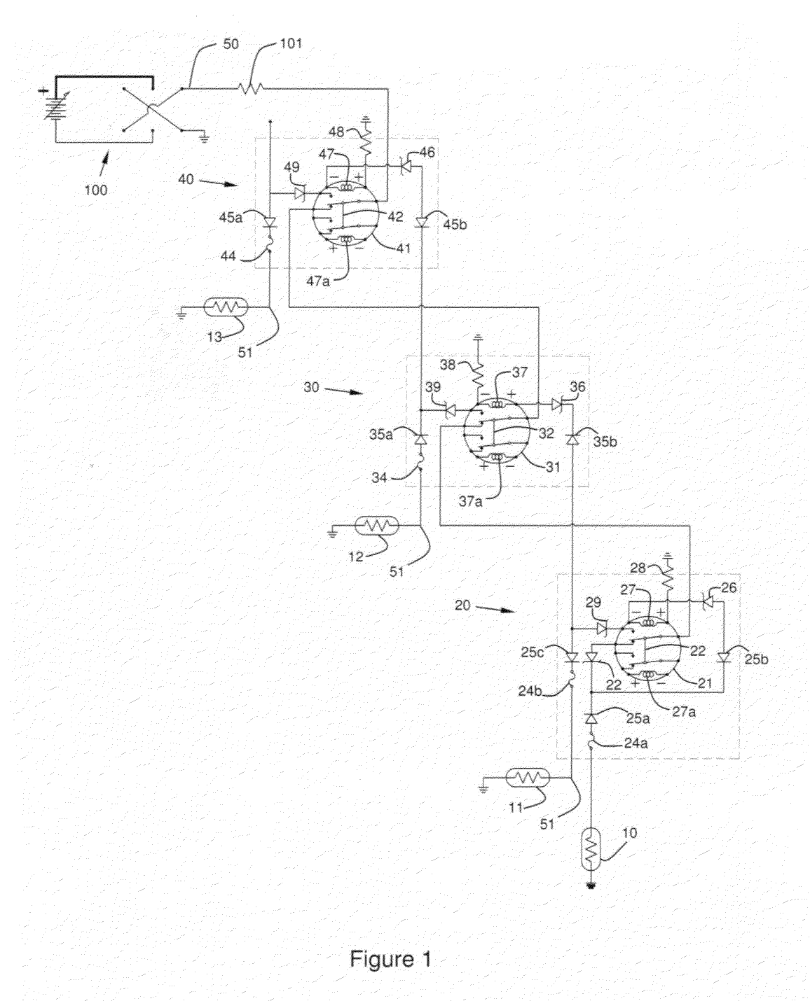

Referring to FIG. 1, one embodiment of an electrical circuit for use with blasting caps to provide an electronic switch is shown. Variable voltage power supply and polarity switch 100, preferably capable of supplying positive or negative voltage from 0 to about 100 VDC, is used to send voltage to supply voltage wire 50, which has internal resistance 101 (about 100 ohms). With the relays as shown in FIG. 1, a negative voltage is applied first. With positive switch relay 41 positioned as shown, the negative voltage passes through negative switch relay 31 and bottom switch relay 21 to Zener diode 22, which blocks voltages below 10 V. Zener diode 22 serves a safety function, not allowing lower stray voltages to pass. Negative voltage is increased to overcome the Zener voltage of Zener diode 22, pass through diode 25a, fuse 24, and activate blasting cap 10, which may have a resistance of 51 ohms. Blasting cap 10 is normally used to activate a bridge plug (not shown), which is activated to form a plug in a casing below perforations. Bottom switch 20 and blasting caps 10 and 11 may not be present if no other device is to be activated in the casing before perforating.

When blasting cap 10 is activated by negative voltage, it becomes an open circuit. The negative voltage then passes through diode 25b and overcome the Zener voltage of Zener diode 26, which may be a 75 V diode. Negative voltage then passes through relay coil 27 (2000 ohm) and resistor 28 (1000 ohm) to ground, switching relay 21. To activate blasting cap 11 for firing the first perforation charge or charges, a positive voltage is applied to line 50, which will then overcome the Zener voltage of Zener diode 29, pass through diode 25c, fuse 24b and blasting cap wire 51 to cap 11. When cap 11 becomes an open circuit, the positive voltage will be applied to coil 37 of relay 31, switching this relay of negative switch 30. The positive voltage is blocked by diode 35a, which blocks voltages below 400 V. Blasting cap 12 may then the activated by applying a negative voltage at power supply and polarity switch 100. When blasting cap 12 becomes an open circuit, the negative voltage passes diode 45b, Zener diode 46 and switches relay 41 of positive switch 40. Subsequently, application of positive voltage may be applied to blasting cap wire 51 and used to activate blasting cap 13. Additional switches may be added, each switch alternating as positive and negative switch, and operating as described for switches 30 and 40.

The components of the circuit illustrated in FIG. 1 may have the following values and identifications:
Blasting caps 10, 11, 12 and 13—51 ohms
Relays 21, 31 and 41—DPDT latching relays, such as Teledyne 422-H-26
22, 29, 39, 49—10 V Zener diode
24a, 24b, 34, 44—1.25 amp fuses
25a, 25b, 25c, 35a, 35b, 45a, 45b—blocking diodes (400 V)
26, 36, 46—75 V Zener diodes
27, 37, 47—2000 ohm relay coils
28, 38, 48—1000 ohm resistors

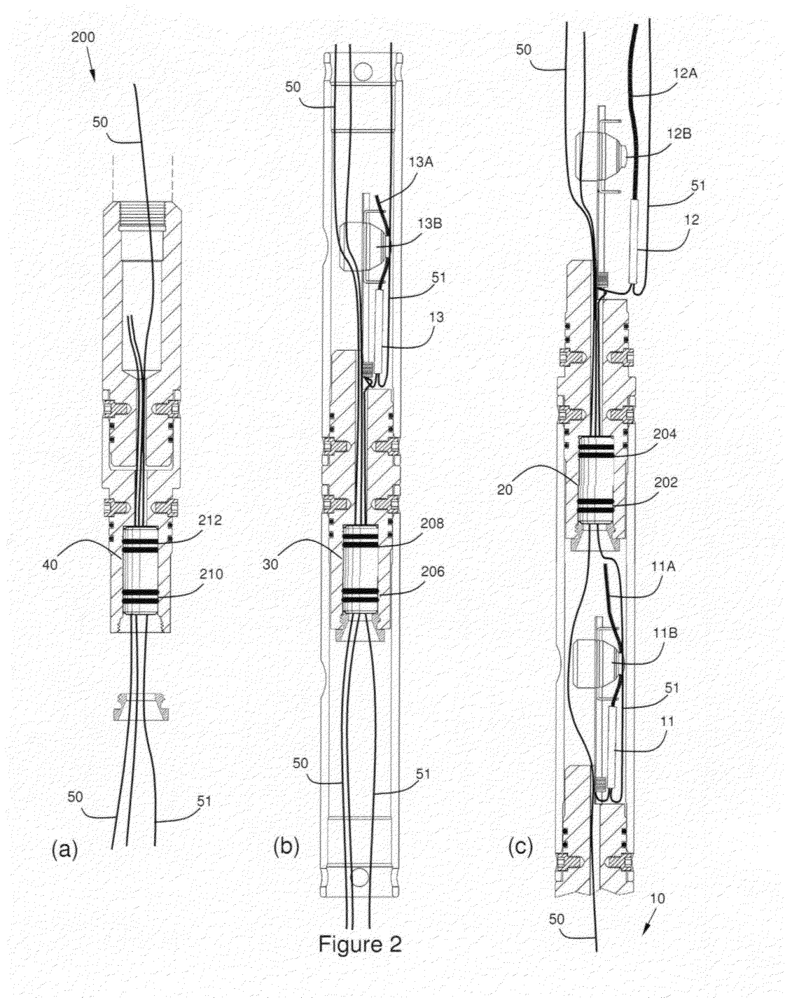

Referring to FIGS. 2(a), 2(b) and 2(c), three sections of select fire perforating device 200 are shown. Positive switch 40 is shown in FIG. 2(a), negative switch 30 in FIG. 2(b) and bottom switch 20 in FIG. 2(c). Supply voltage wire 50 enters the top of device 200 in FIG. 2(a). A selected number of switches such as the positive switch 40 and negative switch 30 may be combined in device 200. Bottom switch 20 may be designed to operate two blasting caps, one of which is electrically connected to wire 50 exiting the bottom of device 200, as shown in FIG. 2(c), and the other is cap 11. Blasting cap 11 is connected to primacord 11A, which causes firing of perforating charge 11B. Charge 11B may be a selected number of charges fired at the same time. Similarly, negative switch 30 is electrically connected to blasting cap 12, which operates as described above on 12A and 12B. Positive switch 40 is electrically connected to blasting cap 13, which operates as described above on 13A and 13B. Seals 202, 204, 206, 208, 210 and 212 prevent well fluids from contacting electronic boards 40A, 30A and 20A.

Dual switch latching relays 21, 31 and 41 (FIG. 1) have two distinct sides, switching and resetting. Relay switching coils 27, 37 and 47 are used to change the state of the switch and allow direct contact between supply voltage line 50 and the next blast cap wire 51. Coils 27A, 37A and 47A are used to verify the state of the latch and reset the switch. Both relay switching wiper connections 27, 37 and 47 and relay resetting wiper connections 27A, 37A and 47A are directly connected internally through a switching and resetting wiper link 32, as shown in the figures. One side of dual switch latching relays cannot be activated without activating the other side.

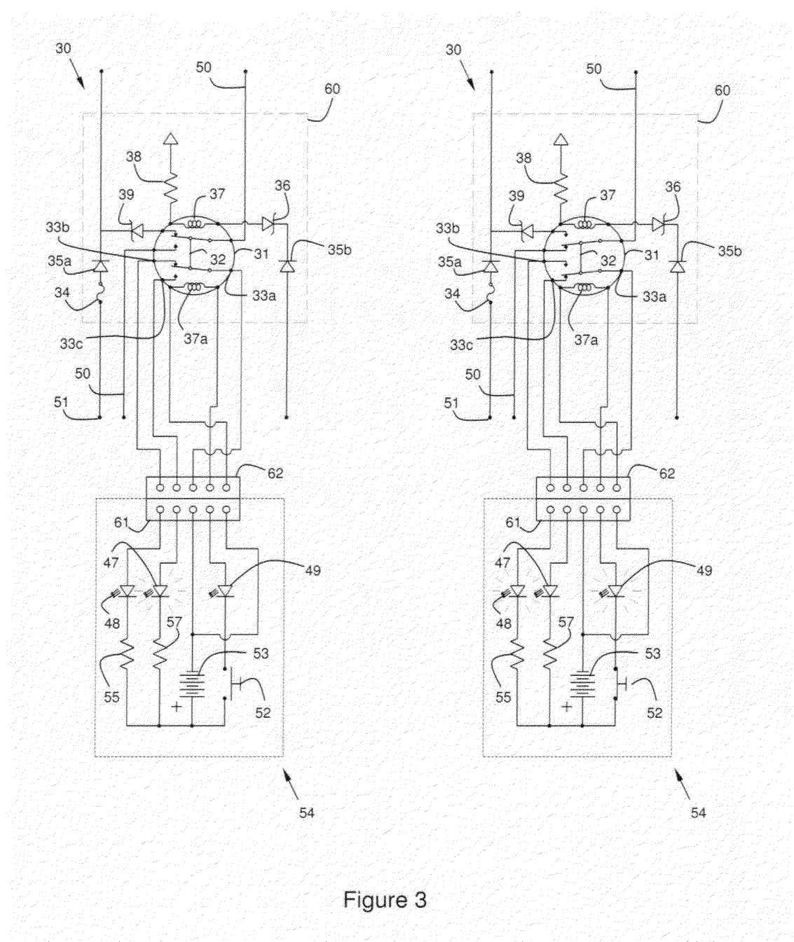

Referring to FIG. 3, an electrical schematic of test and resetting circuit device 54 is shown during the process of resetting negative switch 30 from the “fired” to the “armed” state. The left hand side of FIG. 3 shows dual switch latching relay 31 of negative switch 30 in the “fired” state. After use in the perforating gun assembly 200, negative switch 30 can be reset and reused. Test and resetting circuit device 54 can be connected through test circuit connector 61 to switch test connector 62 mounted on printed circuit board 60 within the negative switch 30, for example. The same applies for positive switch 40. Once test and resetting circuit device 54 is connected to a “fired” negative switch 30, red “fired” light emitting diode (LED) 47 is illuminated by current passing through a circuit made through DC power supply 53, test circuit connector 61, switch test connector 62 and relay resetting wiper connection 33a on the dual switch latching relay 31, out to normally-open resetting wiper connection 33b, back to switch test connector 62, test circuit connector 61, through LED 47, and 2 k ohm resistor 51. Resetting of the negative switch 30 dual switch latching relay 31 is accomplished by depressing the normally-open push button switch 52. When push button switch 52 is depressed, it completes two circuits. The first circuit allows current to flow through push button switch 52, the green “reset” light emitting diode (LED), test circuit connector 61 switch test connector 62, relay positive resetting coil connection of relay coil 37A on the dual switch latching relay 31 of negative switch 30, through the relay negative coil connection, back to the switch test connector 2, into the test circuit connector 61 and into the negative side of the 16-24 VDC power supply 53. This circuit allows relay resetting coil 37A to switch the relay switching wiper connection 32 and relay resetting wiper connection 33a connected through the switching and resetting wiper link 32, from the “fired” state to the “armed” state. Once relay resetting coil 37A is energized, the “armed” circuit is completed. The “armed” circuit is made when LED 48 is illuminated by current passing through a circuit made through DC power supply 53, test circuit connector 61, switch test connector 62, relay resetting wiper connection 33a on the dual switch latching relay 31, out to the normally-closed resetting wiper connection 33c, back to switch test connector 62, test circuit connector 61, through LED 48, and 2 k ohm. resistor 55. Once dual switch latching relay 31 is in this final state, illustrated on the right-hand side of FIG. 3, negative switch 30 is ready for removal of the test and resetting circuit device 54 and loading within the perforating gun assembly 200.

A suitable relay for the disclosed apparatus is model 422H or 422KH dual switch latching relay available from Teledyne, Inc. A suitable Zener diode is 1N5347, 10V Zener Voltage, available from ON Semiconductor. or 1N5374 75 Zener Voltage, available from ON Semiconductor. The range depends on the shooting voltage of the perforating assembly.

Although the present invention has been described with respect to specific details, it is not intended that such details should be regarded as limitations on the scope of the invention, except to the extent that they are included in the accompanying claims.

We claim:

1. Apparatus for selectively activating a device in a well, comprising:
an electrical conductor for placing in the well and a source of positive and negative variable DC voltage for applying to the electrical conductor; and
a plurality of electronic relays electrically connected to the electrical conductor and interconnected, the relays being set to conduct the voltage to a first relay, the first relay being connected to a first diode in series with a first blasting cap, wherein application of a first polarity voltage to overcome the first diode fires the first blasting cap and shifts the first relay such that application of a second polarity voltage to overcome a second diode fires a second blasting cap, wherein each of the blasting caps activates at least one device in the well.

2. The apparatus of claim 1 wherein the device in the well is a perforating gun.

3. The apparatus of claim 1 wherein the device in the well is a bridge plug.

4. The apparatus of claim 1 further comprising diodes to block a stray voltage.

5. The apparatus of claim 1 wherein the electronic relays are double-pole double-throw latching relays and further comprising a circuit to verify the position of the relays or to reset the position of the relays.

6. A method for selectively activating a device in a well, comprising:
providing an electrical conductor for placing in a well and a source of positive and negative variable DC voltage;
providing a circuit comprising a plurality of electronic relays, diodes and blasting caps;
setting the relays such that application of a DC voltage will pass through the relays to a bottom relay;
lowering the circuit into the well on the electrical conductor;
applying a DC voltage to the electrical conductor to overcome a first diode connected to the bottom relay to activate a first blasting cap; and
applying a DC voltage of an opposite polarity to overcome a second diode and activate a second blasting cap.

7. The method of claim 6 wherein the first blasting cap activates a bridge plug.

8. The method of claim 6 wherein the second blasting cap activate a perforating gun.

9. The method of claim 6 further comprising resetting the relays.
